(19) United States
(12) Patent Application Publication
(10) Pub. No.: US 2003/0170587 A1
(43) Pub. Date: Sep. 11, 2003

(54) Post-shaped element for determining spatial position, especially of an implant

(76) Inventors: Michael Augthun, Aachen (DE); Manfred Peters, Wolfenbuttel (DE); Klaus Haselhuhn, Aachen (DE); Hubertus Spiekermann, Haan (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/257,995

(22) PCT Filed: Apr. 5, 2001
(86) PCT No.: PCT/EP01/03856

(30) Foreign Application Priority Data
Apr. 19, 2000 (DE) 10019332.3

(51) Int. Cl. A61C 8/00; A61C 19/04

(52) U.S. Cl. 433/72; 433/173

(57) ABSTRACT

A post-shaped element for determining the spatial position of an implant (10), or the opening cross-section of an artificial indentation located in a tooth or in the stroma of a human or animal body, relative to the tissue structures surrounding it, can be introduced with a receiving section (26A) into an adapted receiving recess (10) in the implant (1) or in the artificial indentation, be affixed therein to be torsion resistant and able to again be removed there-from. In a connecting position the post-shaped element protrudes with a cantilever section (26K) beyond the opening cross-section of the receiving recess (10) or artificial indentation. To be able to easily remove the post-shaped element embedded in the impression mass, even in the case of a slanted position of the implant (1) or the longitudinal axis of the artificial indentation in relation to the surrounding tissue structures, it is suggested to ensure that the post-shaped element consists of a bottom portion (24), which can be torsion-resistantly fixated in the receiving recess (10) or the artificial indentation, and a top portion (25), which can be inserted torsion-resistantly in the bottom portion (24) or placed on said portion, wherein the top portion (25), proceeding from the connecting position of the post-shaped element, can be removed in a linear fashion from the bottom portion (24) in various directions.

The invention relates to a post-shaped element for determining the spatial position of an implant, or the opening cross-section of an artificial indentation located in a tooth or in the stroma of a human or animal body, relative to the surrounding tissue structures wherein the post-shaped element with receiving recess can be introduced into an adapted receiving recess in the implant or in the artificial indentation, be fixed therein to be torsion resistant, and again be removed therefrom, where the connecting position protrudes with a cantilever section beyond the opening cross-section of the receiving recess or the artificial indentation.

In dentistry such post-shaped elements are described as so-called impression posts, which for example, make it possible to determine the position and alignment of a dental implant previously introduced into a jawbone. For this purpose the post-shaped element is inserted with the bottom portion designed as a receiving section into a bore in the implant functioning as a receiving recess and fixated therein, for example, with the help of an axially connecting screw in a threaded bore on the inside of the implant. The cantilever section protruding into the implant beyond the opening cross-section in the connecting position of the post-shaped element is typically equipped with multiple retention features in order to establish as close a positive lock between the cantilever section and a curable impression mass as possible.

With the aid of an impression tray the space around the impression post as well as the neighboring teeth is filled in with an impression mass that is initially moldable, making a kind of negative impression to be created of the teeth and the impression post.

In an area that is allocated to the proximal end of the cantilever section of the impression post, the impression tray exhibits a recess in order to be able to twist the fixating screw out after the impression mass has been able to cure. After the fixation of the post-shaped element in the implant has been eliminated again, the post-shaped element, which is positively embedded in the impression mass, can be removed together with the mass from the jaw.

The disadvantage in this context with familiar post-shaped elements is that with a slanted position of the implant and/or a longitudinal axis of the artificial indentation the direction in which the impression post can be pulled off together with the cured impression mass no longer agrees with the longitudinal axis of the impression post in the direction of which a removal of the receiving section from the receiving recess is solely possible. A removal of the impression mass and the post-shaped element in such cases of slanted positions can only be accomplished when taking advantage of the elastic properties of the impression mass, wherein there is the risk that in the case of a larger excursion of the post-shaped element from the position it assumed when the impression was made a plastic deformation of the impression mass, i.e. a distortion of the position of the impression post in the impression mass occurs.

The invention's purpose is to suggest a post-shaped element used to determine the spatial position, especially of an implant, from which even the post-shaped element can be removed easily without distorting the impression quality in the case of greater slanted positions of the implant in relation to the neighboring teeth or tissue structures.

Proceeding from a post-shaped element of the above-described kind, this task is resolved pursuant to the invention in that the post-shaped element consists of a bottom portion that is torsion-resistantly fixed in the receiving recess or the artificial indentation and a top portion that can be torsion-resistantly inserted into the bottom part or placed thereon, wherein the upper portion, proceeding from the connecting position of the post-shaped element, can be removed in a linear fashion from the bottom portion in various directions.

While the bottom portion is supported on the inner surface area of the receiving recess, which is generally cylindrical or slightly conical, and thus can basically be removed only in one direction from the implant, the separating plane between the bottom portion and the top portion is designed such that the upper portion can be removed in a linear fashion from the bottom portion within a reasonable angular range of up to for example 30° in any random direction. This freedom in selecting the direction when separating the upper portion from the lower portion makes it possible to ensure even in greater slanted positions of the implant or the artificial indentation in relation to surrounding body structures that the portion of the post-shaped element that is embedded in the impression mass can be removed easily without having to take advantage of doubtful elastic properties of the impression material. The quality of the impression and the reliability in determining the alignment of an implant can be increased considerably with the help of the invention in the case of slanted positions.

The bottom portion preferably has a conical or truncated indentation or that of a pyramid or a truncated pyramid, into which a distal end section of the top portion of complementary design can be inserted. This way the bottom portion and top portion can rest securely in the connecting position and yet freedom in selecting the removal direction is still maintained within the respective cone or pyramid angle.

Alternatively, the task on which the invention is based, proceeding from a post-shaped element of the above-described kind, is also resolved in that the cantilever section rests with a stop surface against a proximal end face of the implant of the tooth or the stroma and the receiving section has a base cross-section the limiting line of which coincides in the connecting position at least in some sections with the limiting line of the opening cross-section of the receiving recess and extending from the base cross-section is tapered in the direction of its distal end in such a way that the post-shaped element, proceeding from the connecting position, can be removed in a linear fashion in various directions from the implant, the tooth or the stroma.

In such a post-shaped element, its receiving section engages with the receiving recess of the implant or the artificial indentation such that in the connecting position of the post-shaped element both a shift and a torsion of the post-shaped element is prevented. It is possible and desirable however to remove the post-shaped element from the implant, the tooth or the stroma, proceeding from the connecting position, in a linear fashion in various directions in order to enable even in the case of a slanted position of the implant or the longitudinal axis of the indentation a simple and undistorted creation of an impression. The post-shaped element pursuant to the invention can be designed as one piece, which makes the production inexpensive and assembly as well as removal easy.

The invention in a further development provides for the base surface of the cone, the truncated cone, the pyramid or the truncated pyramid to be arranged in the same plane as an opening cross-section of the receiving recess.

When the base surface of the cone, the truncated cone, the pyramid or the truncated pyramid is congruent to the opening cross-section of the receiving recess, the best possible fixation of the post-shaped element in the connecting position is ensured so that the post-shaped element cannot be shifted from the target position without difficulty due to the impression mass when taking the impression.

The correct assumption of the connecting position of the post-shaped element can be checked easily by verifying whether the upper portion in the connecting position rests with one stop surface against its proximal end face of the implant. The stability of the connection is thus increased further as well, as is the security from an unintentional excursion during the impression process.

When the aperture angle of the cone, truncated cone, pyramid or truncated pyramid is between 5° and 20°, molding without distortion can be guaranteed for almost all slanted positions occurring in practice.

One particularly beneficial fixation of the bottom part in the implant, which additionally is easily reversible, consists of equipping the bottom portion on its distal end with at least one clip element, which with a radially outward protruding projection can positively engage with an indentation in the inner surface area of the receiving recess.

When the post-shaped element is equipped with a connecting centrally arranged through-hole for guiding a rod element through, on one hand the fixation of the post-shaped element during impression can be improved. On the other hand, this also offers the possibility of checking with the help of the rod element the correct position of the post-shaped element in relation to the implant or the tooth before preparing the impression.

Securing the post-shaped element from being shifted unintentionally while taking the impression can be further increased when the post-shaped element can be temporarily glued with a stop surface of the cantilever section onto a proximal end face of the implant, the tooth or the stroma.

Finally, pursuant to one embodiment of the invention, the post-shaped element is an impression post for determining the spatial position of a dental implant.

The post-shaped element pursuant to the invention is explained in more detail in the following with the help of one example, which is shown in the drawing.

It shows:

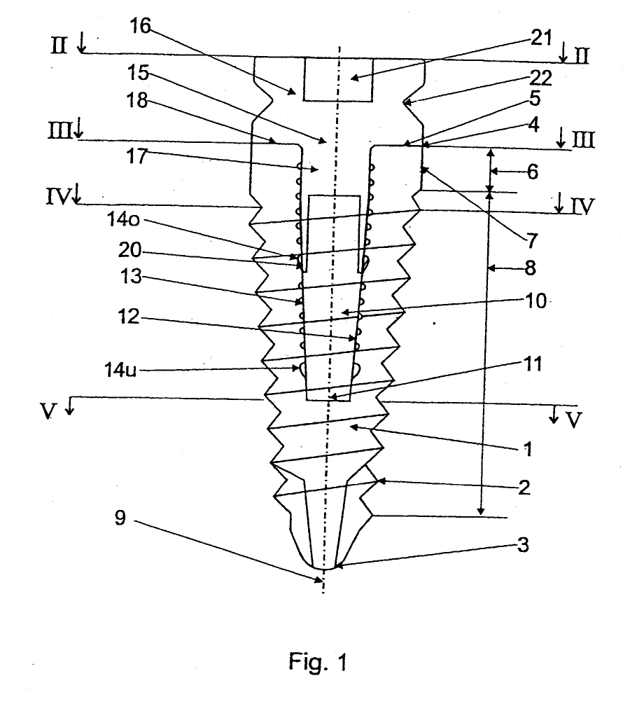

FIG. 1 an implant with a clipped-on cap in a longitudinal sectional view;

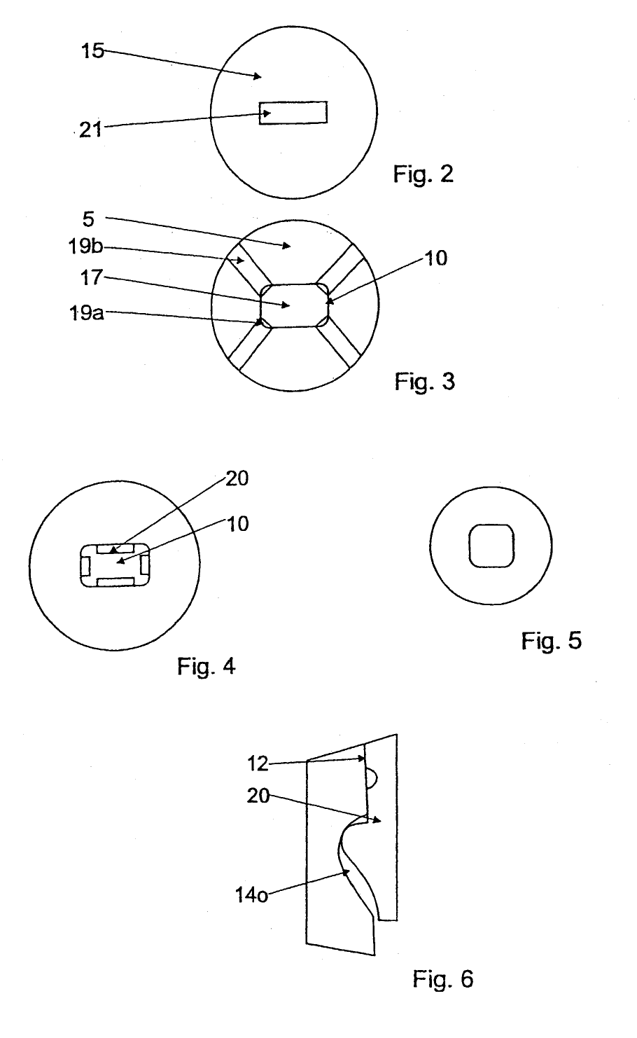

FIG. 2 a top view onto the cap;

FIG. 3 a top view onto the implant upon removal of the cap;

FIG. 4 a cross-sectional view along line IV-IV through the implant pursuant to FIG. 1;

FIG. 5 a cross-sectional view along line V-V through the implant pursuant to FIG. 1;

FIG. 6 an enlarged section of the engagement area of a clip element;

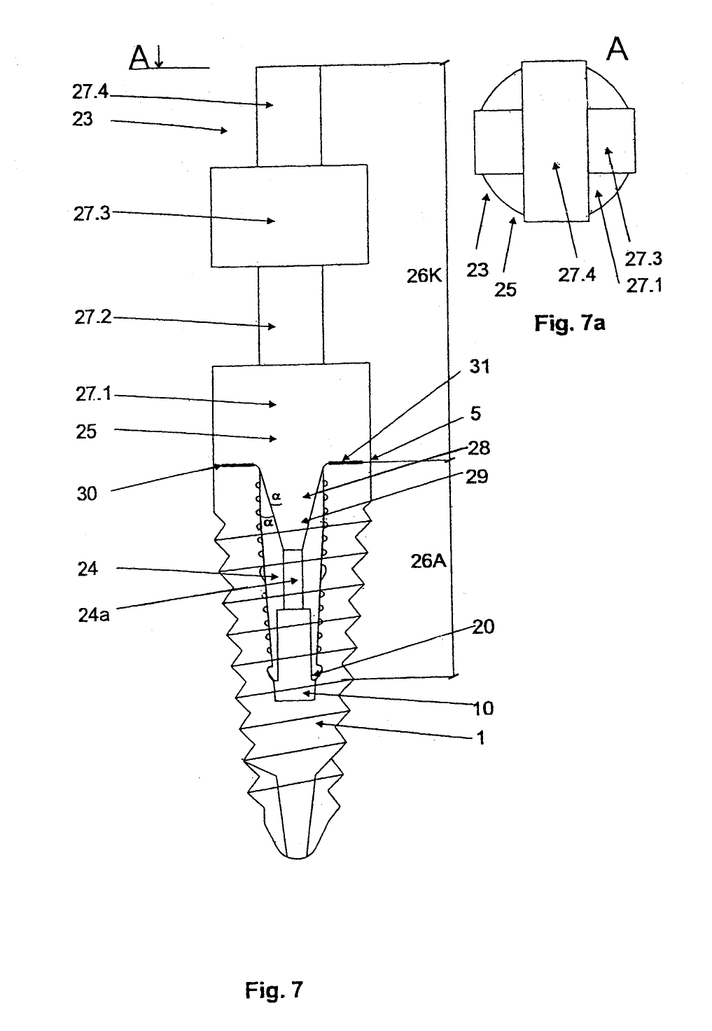

FIG. 7 the implant with a clipped-on impression post in a longitudinal cross-sectional view;

FIG. 7a a top view onto the upper portion of the impression post pursuant to FIG. 7;

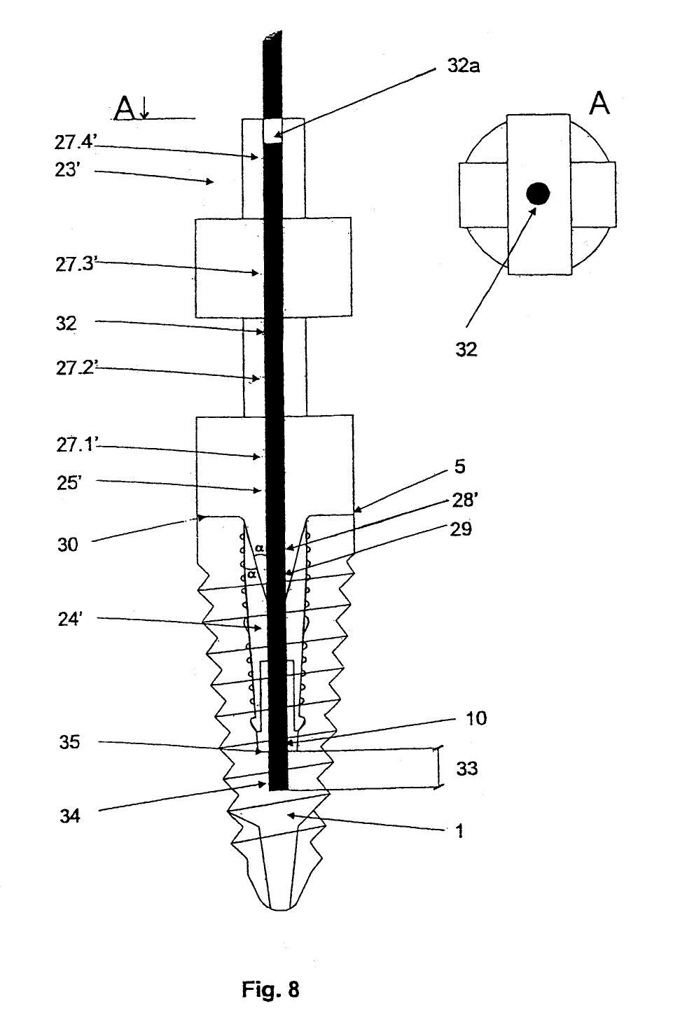

FIG. 8 an alternative implant with an impression post with a rod element in a longitudinal cross-sectional view, and

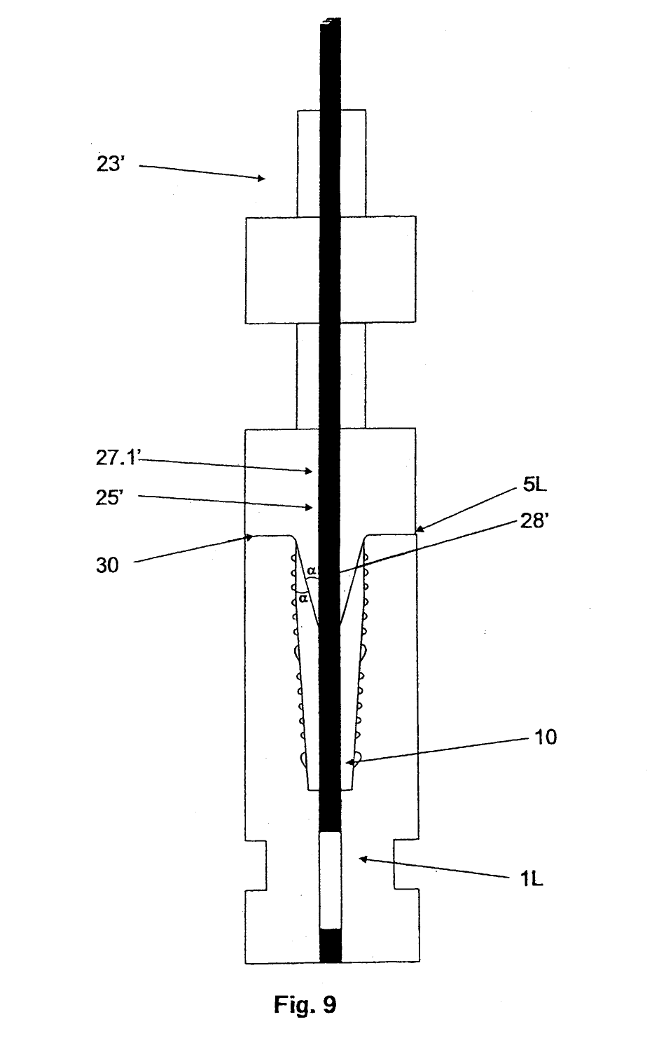

FIG. 9 as in FIG. 8, however of a lab implant.

FIGS. 1 through 5 reveal an implant 1 consisting of titanium, which has a roughly conical base shape and on its outer surface area contains an outer thread 2. The implant 1 contains a rounded-off distal end 3 and a proximal end 4, which is formed by a largely circular end face 5. In a section 6 following the end face 5, the implant 1 exhibits cylindrical shape with a high-polished surface area 7. In a threaded area 8 that follows, the implant 1 has a conical design. Starting from the end face 5, parallel to the longitudinal axis 9 of the implant, a receiving recess 10 extends, which runs across the entire length of the section 6 as well as a portion of the length of the threaded section 8.

As FIG. 3 shows, the cross-section of the receiving recess 10 takes on the shape of a rounded-off rectangle in the area of the section 6. Starting with the threaded area 8, the cross-section of the receiving recess 10 tapers continuously so that on the base 11 of the receiving recess 10 the cross-section has the shape of a rounded-off square (see FIG. 5). The transition from the rounded-off rectangular to the rounded-off square cross-sectional shape occurs continuously and smoothly.

As particularly FIG. 1 shows, the wall 12 of the receiving recess 10 contains a plurality of ring grooves 13, which are aligned vertical to the longitudinal axis 9. Furthermore the wall 12 is equipped with an upper and a lower ring groove 14o and 14u, the function of which is explained below.

The implant 1 depicted in FIG. 1 is inserted in a cap 15, consisting of a roughly cylindrical head portion 16 and a coaxially thereto aligned connecting broach 17, which extends in the receiving recess 10. A contact surface 18 of the head portion 16 rests positively on the end face 5 of the implant 1.

As FIG. 3 reveals, the connecting broach 17 has in its upper section a roughly rectangular cross-section, wherein the corner areas are broken in such a way that in the rounded-off areas of the cross-section of the receiving recess 10 between the connecting broach 17 and the wall 12 of the receiving recess 10 four ventilation ducts 19a are formed. Air displaced when inserting the connecting broach 17 in the receiving recess 10 can thus flow out upward without causing a pressure build-up that would impair the assembly process, wherein the air can escape to the outside through four radially outward extending ventilation grooves 19b, which are incorporated in the end face 5 of the implant and communicate with the ventilation ducts 19a.

In the installed state of the cap 15, the outer surface areas of the connecting broach 17 and the wall 12 of the receiving recess 10 as well as the end face 5 and the contact surface 18 rest positively against each other.

Since the cap 15 remains on the implant 1 only temporarily after implantation, it is connected with the implant 1 only through four clip elements 20, which engage with the clip groove 14o. Instead of the engagement of the clip elements 20 in the upper clip groove 14o shown in FIG. 1, engagement in the lower clip groove 14u is also possible with an appropriately extended connecting broach 17.

The cap 15 is inserted into the implant 1 already by the implant manufacturer and upon preparation of an appropriate bore in the bone serves the purpose of screwing the implant 1 in with the help of a screwdriver, which engages with the slot 21 shown in FIG. 2. Due to the roughly rectangular cross-section of the connecting broach 17 and the adapted receiving recess 10, the introduction of moments of torsion into the implant 1 is possible via the cap 15. Upon implantation, the cap 15 remains on the implant 1 in order to protect also the receiving recess 10 from outside contamination.

Approximately 3 to 6 months after insertion of the implant 1 in the jaw bone, the healing process is completed far enough to be able to open up the mucous membrane covering the cap 15 in a second surgery. The cap 15 is removed, which is accomplished by reaching into a V-shaped ring groove 22 in the head portion 16 with the help of a tool in the shape of tongs and removing the entire cap 15 upward from the implant with a slight jerk in the axial direction. Into the receiving recess 10 of the implant 1 now a connecting broach 17 of a gingiva former is inserted, which is not shown in the figures. The fastening principle of the gingiva former is the same as with the cap.

In order to be able to adapt a replacement tooth, which is to be anchored in the implant 1, outside the mouth area of the patient to a model of the jaw, an impression of the teeth is prepared. For this purpose, a post-shaped element, which is shown in FIG. 7, in the shape of an impression post 23 is inserted into the receiving recess 10 of the implant. The impression post 23 consists of a bottom portion 24, which can be fixated with four clip elements 20, and a top portion 25, which can be torsional-resistantly inserted into the bottom portion 24. The top portion 25 protrudes with a cantilever section 26K beyond the opening cross-section of the receiving recess 10 and is composed of four cuboid elements 27.1 through 27.4. The lowest element 27.1 exhibits a conical end section 28 with an elliptic cross-section, which engages with an indentation 29 of complementary design in the bottom portion 24 of the impression post 23. The bottom portion 24 has the same length as a receiving section 26A of the implant 1 and with its upper edge ends flush with the end face 5 of the implant 1. The indentation 29 extends directly from the level of the end face 5 and has an opening cross-section that is only slightly smaller than the opening cross-section of the receiving recess 10 in the implant 1 itself.

As the top view onto the top portion 25 of the impression post 23 pursuant to FIG. 7a reveals, the cuboid elements 27.1 through 27.4, which have a rectangular outline, are turned towards each other alternately by 90°, i.e. in a cross-shaped stacked manner.

The lowest element 27.1 of the top portion 25 of the impression post 23 rests with its circular contact surface 30 against the end face 5 of the implant 1, wherein for the purpose of secure fixation of the impression post 23 to the implant 1 on the contact surface 30 after the preparation of the impression post 23, which is done in an injection molding process, a thin peripheral adhesive ring 31 is applied, which can be removed with a slight jerky movement again from the end face 5 of the implant 1 after the impression has been taken.

Proceeding from the connecting position shown in FIG. 7, the top portion 25 of the impression post 23 is surrounded by a viscous and curable impression mass. After the curing process, the impression post 23 cannot be removed any longer from the impression mass in the area of its top portion 25 without destroying the positive connection. Rather the impression tray, which contains the impression mass, is removed together with the impression post 23, wherein the adhesive connection established by the adhesive ring 31 is removed by applying a slight jerky movement. Due to the conical connection with elliptic cross-section between the top portion 25 and the bottom portion 24 of the impression post 23, the top portion 25 can be removed in a linear fashion from the implant 1 and/or the initially remaining bottom portion 24 in various directions. The limits of the possible directions are defined by the surface area of the cone of the end section 28 and/or the complementary indentation 29 when said surface area is extended upward beyond the end face 5 of the implant 1. Due to the special connection of the bottom portion 24 with the top portion 25, the latter can be removed from the mouth area without tension and without applying force onto the impression mass even if the longitudinal axis of the implant 1 exhibits a quite considerable slanted position in relation to the neighboring teeth. In the bottom portion 24 a through-hole 24a is incorporated. With the help of e.g. hooked or expanding tongs—inserted through the bore 24a—the bottom portion 24 can then be pulled out of the implant later on with a slight axial force.

The impression post 23′ depicted in FIG. 8 differs from the impression post 23 pursuant to FIG. 7 in that it contains a continuous centrally arranged through-hole, in which an adapted rod element 32 is inserted. The rod element 32, which extends through all elements 27.1′ through 27.4′, penetrates with its distal end section 33 into a thereto adapted opening 34 in the base 35 of the receiving recess 10. The through-hole for the rod element 32 also extends through the end section 28′ of the cylindrical element 27.1′ as well as the bottom portion 24′.

The rod element 32 for one allows the correct positioning of the impression post 23′ to be checked, specifically when in the proximal end section of the rod element 32 at least one marking 32a is incorporated, which for example either just barely has disappeared in the through-hole of the upper most element 27.4′ or has not quite entered the through-hole yet when the contact surface 30 of the element 27.1′ rests correctly against the end face 5 of the implant 1.

Another advantage of the rod element 32 is the fact that this way the impression post 23′ receives greater stability. In particular it prevents that during the impression process the top portion 25′ of the impression post 23′ can shift relative to the bottom portion 24′, for example through force that is applied by the impression mass.

FIG. 9 finally shows how the impression post 23′ after the impression process is inserted into a lab implant 1L, the receiving recess 10 of which agrees with that of the original implant 1 pursuant to FIG. 8. The bottom portion 24′ of the impression post 23′ has not been inserted into the receiving recess 10 in the depiction pursuant to FIG. 9. The top portion 25′ of the impression post 23 in this case is rather kept by the end section 28′ on the lower element 27.1′ in its correct connecting position, in which the contact surface 30 rests against the end face 5L of the lab implant 1L.

Additionally, the rod element 32 enters with its distal end 33′ into a bore 34′ in the base 35′ of the receiving recess 10′. This ensures a correct connecting position between the lab implant 1L and the impression post 23′.

1. Post-shaped element for determining the spatial position of an implant (10), or the opening cross-section of an artificial indentation located in a tooth or in the stroma of a human or animal body, relative to the tissue structures surrounding it, wherein the post-shaped element with a receiving recess (26A) can be introduced into an adapted receiving recess (10) in the implant (1) or in the artificial indentation, be fixed therein to be torsion-resistant, and again be removed therefrom, where the connecting position protrudes with a cantilever section (26K) beyond the opening cross-section of the receiving recess (10) or the artificial indentation, characterized by the fact that the post-shaped element consists of a bottom portion (24, 24′), which can be adapted to the receiving recess (10) or the artificial indentation, and a top portion (25, 25′), which can be placed on top, where the top portion (25, 25′), proceeding from the connecting position of the post-shaped element, can be removed in a linear fashion from the bottom portion (24, 24′) in various directions.

2. Post-shaped element pursuant to claim 1, characterized by the fact that the bottom portion (24, 24′) includes a conical, truncated conical, pyramid-shaped or truncated pyramid indentation (29), into which a distal end section (28, 28′) of complementary design of the top portion (25, 25′) can be inserted.

3. Post-shaped element for determining the spatial position of an implant (10), or the opening cross-section of an artificial indentation located in a tooth or in the stroma of a human or animal body, relative to the tissue structures surrounding it, wherein the post-shaped element with a receiving section (26A) can be introduced into a receiving recess (10) in the implant (1) or in the artificial indentation in a torsion-resistant manner and removed therefrom again and in a connecting position protrudes with a cantilever section (26K) beyond the opening cross-section of the receiving recess (10) or the artificial indentation, characterized by the fact that the cantilever section (26K) rests with a stop surface (30) against a proximal end face (5) of the implant (1) of the tooth or the stroma and that the receiving section (26A) has a base cross-section, the limiting lines of which coincide in the connecting position, at least in some sections, with the limiting line of the opening cross-section of the receiving recess (10) and, extending from the base cross-section, is tapered in the direction of its distal end such that the post-shaped element, proceeding from the connecting position, can be removed in a linear fashion from the implant (1) in various directions.

4. Post-shaped element pursuant to claim 3, characterized by the fact that the receiving section (26A) takes on the shape of a cone, a truncated cone, a pyramid or a truncated pyramid.

5. Post-shaped element pursuant to one of the claims 1 through 4, characterized by the fact that the base surface of the cone, truncated cone, pyramid or truncated pyramid is arranged in the same plane as an opening cross-section of the receiving recess (10).

6. Post-shaped element pursuant to one of the claims 2 through 5, characterized by the fact that the base surface of the cone, truncated cone, pyramid or truncated pyramid is congruent with the opening cross-section of the receiving recess (10).

7. Post-shaped element pursuant to one of the claims 1 through 6, characterized by the fact that the top portion (25) in the connecting position rests with a stop surface (30) against a proximal end face (5) of the implant (1).

8. Post-shaped element pursuant to one of the claims 2 through 7, characterized by the fact that the aperture angle of the cone, truncated cone, pyramid or truncated pyramid is between 5° and 20°.

9. Post-shaped element pursuant to one of the claims 1 through 8, characterized by the fact that the bottom portion (24) at its distal end is equipped with at least one clip element (20), which with a radially outward protruding projection can positively engage with an indentation in the inner surface area of the receiving recess (10).

10. Post-shaped element pursuant to one of the claims 1 through 9, characterized by the fact that it is equipped with a continuous centrally arranged through-hole for guiding a rod element (32) through.

11. Post-shaped element pursuant to one of the claims 1 through 10, characterized by the fact that with a stop surface (30) of the cantilever section (26K) it can be glued on a temporary basis to a proximal end face (5) of the implant (1) of the tooth or the stroma.

12. Post-shaped element pursuant to one of the claims 1 through 11, characterized by the fact that it is an impression post (23, 23′) for determining the spatial position of a dental implant (1).
